(19) United States
(12) Patent Application Publication
(10) Pub. No.: US 2023/0101645 A1
(43) Pub. Date: Mar. 30, 2023

(54) AN ATTACHABLE REFUSE DISPOSAL RECEPTACLE

(71) Applicant: Shalana Paulhill, Clayton, DE (US)

(72) Inventor: Shalana Paulhill, Clayton, DE (US)

(21) Appl. No.: 17/954,915

(22) Filed: Sep. 28, 2022

Related U.S. Application Data
(60) Provisional application No. 63/249,342, filed on Sep. 28, 2021.

(51) Int. Cl. A61J 19/00; B65D 77/24; B65F 1/00

(52) U.S. Cl. CPC A61J 19/00; B65D 77/24; B65F 1/0006

(57) ABSTRACT

One or more embodiments are disclosed of a receptacle for collecting inedible food items discarded by spitting, such popcorn husks and seed shells. The receptacle comprises a receiving unit that has a upper end depending downward toward a collection unit and may generally have a funnel like shape. The receiving unit is configured to contain an act of spitting out inedible bits of food by an individual, making it more discrete and preventing the spread of germs. The collection unit is connected to the lower end of the receiving unit. The collection unit may include a closed end or an end that is closed by a connectable cap. The receptacle can be provided in bag having an adhesive backing that can adhere to a container, or in an alternate embodiment, the receptacle includes an attachment piece that can hook onto a lip of the container.

### CROSS-REFERENCE TO RELATED APPLICATIONS

This application is a non-provisional application which claims priority to U.S. Provisional Pat. Application No. 63/249,342 filed on Sep. 28, 2021, which is incorporated by reference in its entirety.

### FIELD OF DISCLOSURE

The present invention relates to the field of receptacles for food items and, more particularly, to a receptacle for disposing popcorn hulls, un-popped popcorn kernels, and seed shells.

### BACKGROUND

Popcorn is a popular snack for people of all ages. Most often, popcorn is associated with movie going and is also often enjoyed at home when watching a movie or show on a home television. Having a bag or bowl of popcorn is part of the movie experience. However, that experience can be dimmed when an un-popped kernel or a hull enters the mouth. For some individuals, one or both can be an unpleasant feature to consume and have in the mouth.

Popcorn is made of dried corn kernels with tough shells that are heated until the steam created inside causes them to pop into the white fluffy edible food. However, because of that tough shell or hull, popcorn still has the thin remains of hull at the center of the piece. The hull is almost like a thin sharp bit that can cause irritation in several ways including and not limited to getting stuck between the teeth and gums, getting caught between the teeth, and getting stuck in the throat and causing a bout of coughing. An un-popped kernel can also be an offending piece in the mouth because it is a hard piece to bite down on and in some cases may cause a damaged tooth such as a cracked or broken tooth.

For these reasons, some people will spit out the hulls and the un-popped kernels. Most often these end up on the floor, back into the popcorn bag or bowl, or into a hand. Neither one of these options is ideal. A similar situation arises when eating seeds which are presented in their shells, such as sunflower seeds. Most often these shells are spat out into a bag or bowl or the ground. Spitting out the hulls, un-popped kernels, and the shells of seeds is not only unsightly but is also unhygienic as germs are dispersed from an individual’s mouth into the air. This is especially true for venues such as sports stadiums, arenas, and movie theaters. The standard practice has never been addressed for these crowded venues, while the germs are spread, and a mess is created on the ground next to another person(s). Existing devices and systems for providing a disposal means are unable to fully provide an easy means and are often overly complex.

Accordingly, there still is an unsolved need for neatly and hygienically disposing of unwanted food items in an individual’s mouth that may address these and other existing issues.

### SUMMARY

One or more embodiments are provided below for a receptacle that allows an individual to consume popcorn, seeds, and other food items with shells, and then neatly and hygienically dispose of the hulls, un-popped kernels, and shells. The receptacle is designed to house the unwanted waste, wherein the receptacle can be attached to another container such as a bowl or a bucket that contains the edible item. For example, the receptacle may be attached to a popcorn bucket. The receptacle comprises a receiving unit and a collection unit, respectively. The receiving unit is adapted such that an individual’s mouth may be placed relatively close to the receiving unit to spit out any undesired bits from the mouth when consuming popcorn or seeds with shells. The receiving unit may also be adapted to encourage any discarded items to travel to the collection unit which is connected to the receiving unit The collection unit of the receptacle is designed to house the discarded waste. The receptacle also includes an attachment element allowing the receptacle to be connected to a bucket or bag containing an item of food to be consumed (e.g., popcorn bag).

In one non-limiting embodiment, the receptacle is fashioned from paper and is provided in a folded state in a bag which has an adhesive seal and backing that can be adhered to a side of a bucket or bag. After use, the receptacle can be folded back into the bag to contain the refuse and disposed with the bucket.

According to a second non-limiting embodiment, the receptacle is reusable and fashioned from a sturdier material. The receptacle includes a clip allowing it to be attached to a bucket or bowl. After use, the receptacle can be cleaned and ready for the next use.

According to these non-limiting embodiments, the receptacle provides a sanitary way to dispose of unwanted food waste from the mouth. The receptacle self-contains the spread of germs to reduce infection as a user spits the unwanted food items directly into the receptacle. Additionally, the receptacle allows unwanted food waste to be disposed of appropriately instead of on the ground creating a mess and filth.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a pictorial illustration of a perspective view of a non-limiting embodiment of a receptacle for spitting out inedible food items in accordance with an illustrative embodiment.

FIG. 2 is a pictorial illustration of a receptacle and a bag the receptacle is provided within in accordance with an illustrative embodiment.

FIG. 3 is a pictorial illustration of the bag the receptacle is stored within attached to a snack bag in accordance with an illustrative embodiment.

FIG. 4 is a pictorial illustration of the receptacle and the provided bag with the receptacle unfolded and ready for use in accordance with an illustrative embodiment.

FIG. 5 is a pictorial illustration of a sleeve on the receptacle being removed and the receptacle is attached to a snack bag in accordance with an illustrative embodiment.

FIG. 6 is a pictorial illustration of a receiving unit on the receptacle being opened in accordance with an illustrative embodiment.

FIG. 7 is a pictorial illustration of an alternate embodiment of a receptacle for spitting out inedible food items in accordance with an illustrative embodiment.

FIG. 8 is a pictorial illustration of a side view of the alternate embodiment of the receptacle in accordance with an illustrative embodiment.

FIG. 9 is a pictorial illustration of the alternate embodiment of the receptacle in accordance with an illustrative embodiment.

FIG. 10 is a pictorial illustration of the alternate embodiment of the receptacle and a snack bag the receptacle can be attached to in accordance with an illustrative embodiment.

FIG. 11 is a pictorial illustration of an attachment piece on the receptacle placed over a lip of a snack receptacle in accordance with an illustrative embodiment.

FIG. 12 is a pictorial illustration of the receptacle attached to a snack receptacle in accordance with an illustrative embodiment.

### DETAILED DESCRIPTION

In the Summary above and in this Detailed Description, and the claims below, and in the accompanying drawings, reference may be made to particular features of the invention. It may be understood that the disclosure of the invention in this specification includes all possible combinations of such particular features. For example, where a particular feature may be disclosed in the context of a particular aspect or embodiment of the invention, or a particular claim, that feature can also be used, to the extent possible, in combination with and/or in the context of other particular aspects and embodiments of the invention, and in the invention generally.

Where reference may be made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” may be used herein to mean “serving as an example, instance, or illustration.” Any aspect described in this document as “exemplary” may not be necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

The present disclosure is generally drawn to various embodiments for a receptacle that provides for a neat and hygienic way to discard popcorn hulls, un-popped kernels, and seed shells that an individual would normally spit out while consuming popcorn or seeds. In particular, the one or more embodiments of a receptacle make it possible for the receptacle to attach to a bag or a bucket for a food item, such as popcorn. Accordingly, a consumer can spit any inedible or undesired bits discretely into the receptacle. This is advantageous as many people will either spit out the bits onto the ground, back into the bag, a napkin, or swallow the undesired bit. The embodiments proved herein may be used with multiple bags and buckets. Further details are provided below with reference to the figures.

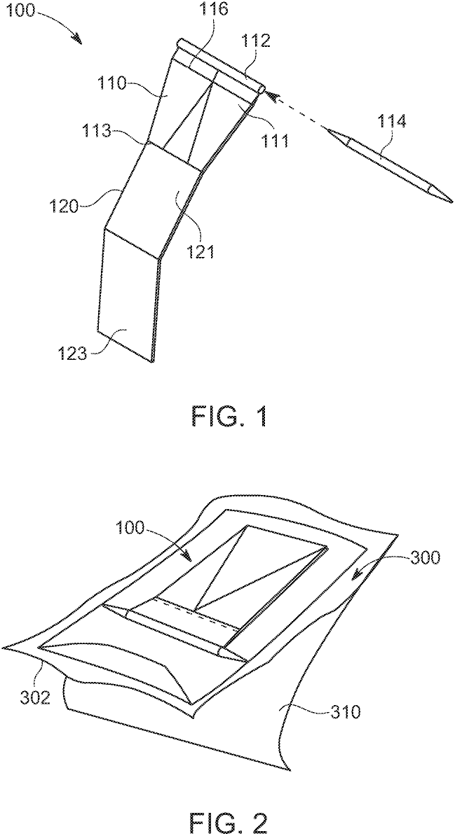

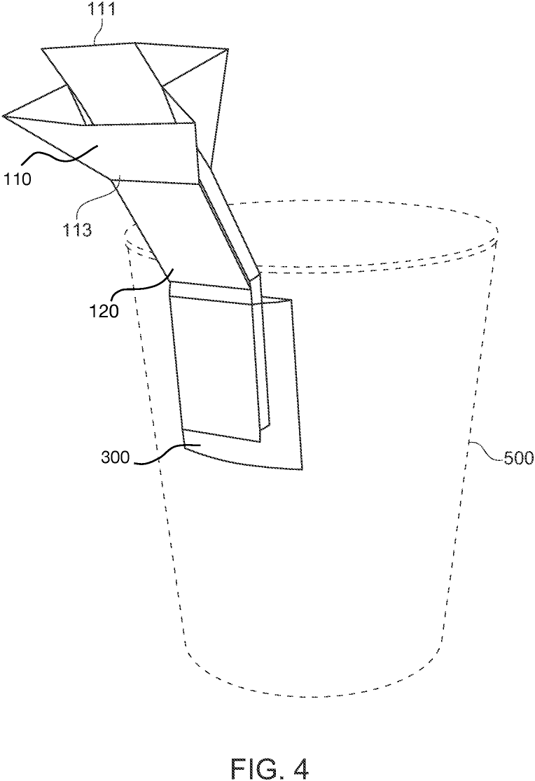

Turning to the figures, FIGS. 1-6 are an illustration of a non-limiting embodiment of a receptacle 100, which is an example of a disposable receptacle for receiving the inedible bits of popcorn and seeds in accordance with a non-limiting embodiment of the present invention. The receptacle 100 described in this embodiment may be useful in a commercial venue, such as a movie theater, sports, arena, music arena, and other venues where food items such as popcorn and seeds may be served. The idea has significance for those places where the receptacle 100 may not ideally be reusable, but where it is intended to be discarded after use and may be recycled or is biodegradable. As discussed above, the receptacle 100 may be defined as having an interior space which is adapted for receiving inedible bits of popcorn and seeds that may be directly spat out into the receptacle 100 from a consumer’s mouth. FIG. 1 illustrates a perspective view of the receptacle 100 and is shown to comprise of a receiving unit 110 and a collection unit 120. The receiving unit 110 and the collection unit 120 are seamlessly connected to each other such that the discarded bits from a consumer’s mouth move into the collection unit 120 from the receiving unit 110. The receptacle 100 may generally be used with a bag or other container from which a consumer may consume an edible snack, such as popcorn or sunflower seeds. FIG. 2 illustrates that the receptacle 100 of the present disclosure may preferably be provided in its own bag, such as a bag 300. The bag 300 has an adhesive backing that allows the bag 300 to be attached to a receptacle 500, as shown in FIG. 4. This allows for ease of use when an inedible bit needs to be spat out. The receptacle 100 may be preferably fashioned from a fibrous material that may be used to make paper and is disposable, biodegradable, or generally eco-friendly. Some examples of a such materials include, and are not limited to, tree fiber, bamboo, cork, cotton, hemp, mulberry, and other fibrous material that can be used to make paper. It is to be understood that the receptacle 100 may also be fashioned from material that is recyclable.

The receiving unit 110 is constructed to permit an easy and hygienic means of spitting into the receptacle 100. Additionally, the receiving unit 110 is also intended to make the act of spitting into the receptacle 100 a bit more discrete. To permit an easy and hygienic means of spitting into the receptacle 100, the receiving unit 110 may have a funnel shape defined by a wider upper end 111 at the opening for a mouth and which depends downward toward a narrower lower end 113 that integrates to the collection unit 120. The advantage of the funnel shaped receiving unit 110 is such that the wider upper end 111 with the narrower lower end 113 helps contain any spray that exits an individual’s mouth when spitting into the receiving unit 110. Another advantage of the funnel shaped receiving unit 110 is also that it allows for discreetly spitting out any inedible bits by placing the mouth close to or within the receiving unit 110. It is to be understood that any other shape that offers discreetness and maintains a hygienic environment by containing the spray exiting an individual’s mouth when spitting out the inedible bits is within the description of the present invention.

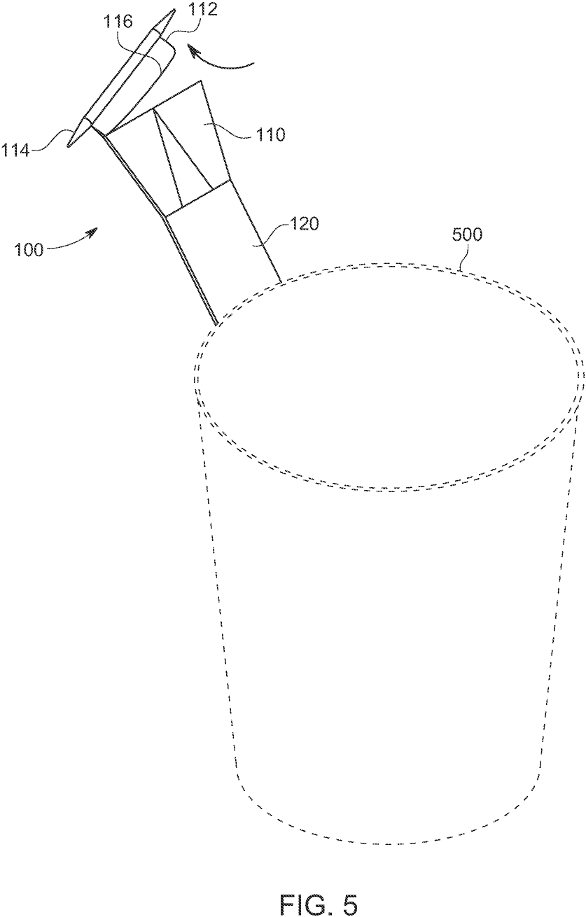

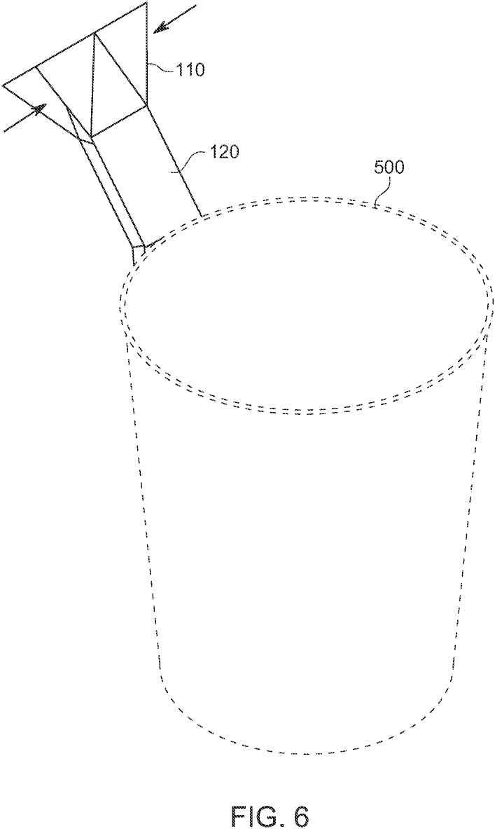

Referring to FIGS. 1, and 4 to 6, the receiving unit 110 of the receptacle 100 is shown to be closed at a top by a sleeve 112 prior to use. Specifically, the upper end 111 of the receptacle is closed by the sleeve 112. The receptacle 100 also comprises of a toothpick 114 which is disposed within the sleeve 112. The sleeve 112 is tubular shaped and dimensioned to fit the toothpick 114 snugly. The toothpick 114 and the sleeve 112 close the top end of the receiving unit 110. The toothpick 114 is provided to help reach difficult places in a consumer’s mouth to remove unwanted particles. As shown in the illustration, each end of the toothpick 114 extends out of the sleeve on their respective ends. This makes it easier for a consumer to pull out the toothpick 114 when needed. As best shown in FIG. 5, the sleeve 112 is shown to have a perforated end 116 that connects to the receiving unit 110, and a consumer would remove the sleeve 112 by tearing at the perforated end 116 to unseal the receiving unit 110. As best shown in FIG. 6, the consumer may pinch sides of the unsealed receiving unit 110 to open the upper end 111 into the funnel shape to arrange the receptacle 100 for receiving any debris being spat out.

The collection unit 120 forms an enclosed space that has an open end 121 and a closed end 123. The collection unit 120 is connected to the lower end 113 of the receiving unit 110, which is opposite the upper end 111. Specifically, the open end 121 is connected to the lower end 113 of the receiving unit 110. The closed end of the collection unit 120 is, as the name suggests, closed to contain the debris spat or blown out by a consumer. The funnel shape of the receiving unit 110 will direct particles down into the collection unit 120. As shown in FIG. 2, the collection unit 120 has a length which is folded. Additionally, the receptacle 100 is also folded at the perforated end 116 allowing the receptacle 100 to be stored within the provided bag 300. The length of the collection unit 120 is such that once the receptacle 100 is removed from within the bag 300 and unfolded, the unfolded length of the collection unit 120 can partially fit within a pocket created by the opened bag 300. It is also to be understood that the length of the collection unit 120 may also fit fully within the pocket of the opened bag 300.

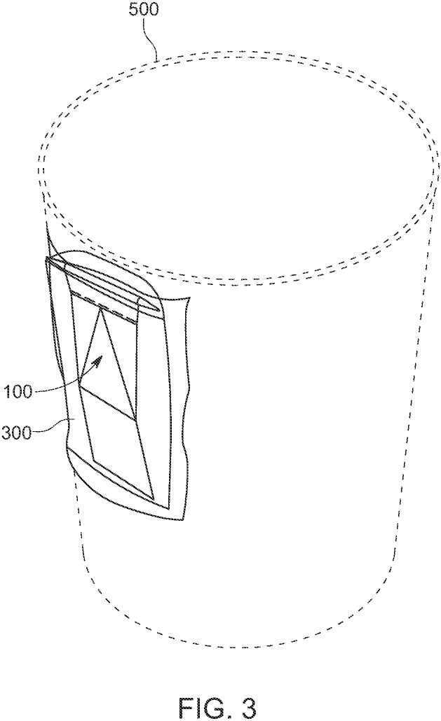

As described above, the receptacle 100 is provided in the bag 300. Referring to FIGS. 2 and 3, the bag has a paper backing 310 which exposes an adhesive backing on the bag 300. The bag 300 can then be adhered to a bag or bucket, such as the bucket 500 shown in FIGS. 3 and 4. The bag 300 also has a seal at a top end 302 of the bag 300 which can be opened to remove the receptacle 100. Additionally, the bag 300 can be resealed at the top end 302. For example, once the receptacle 100 has been used, the consumer can fold the receptacle 100 back into the bag 300 and seal the bag 300 to contain any waste.

To use, a consumer would pick up the bag 300 with the receptacle 100 from a condiments station. The consumer would remove the paper backing 310 to expose the adhesive back of the bag 300 and place the adhesive back against the side of a bucket/bag 500 with a food item. The bag 300 would be placed upright so the top end 302 of the bag 300 is facing upward. To remove the receptacle 100, the bag 300 is opened by unsealing the top end 302. The receptacle 100 is pulled out and unfolded. The receptacle unit 120 is placed back into the bag with the closed end 123 at a bottom of the bag. The sleeve 112 is removed from the receiving unit 110 by tearing at the perforated end 116. The sleeve 112 with the toothpick 114 may be placed back into the bag for later use, if needed. The receiving unit 110 is fully opened by pressing on the sides of the upper end 111. Generally, the receptacle 100 is faced toward the consumer, so the consumer can place their face close to the receiving unit 110 to spit or blow out and unwanted bits in the mouth to prevent or reduce contamination. The toothpick 114 may be accessed from the bag 300 to remove any stuck particles. The receptacle 100 can be folded back into the bag 300 to discard.

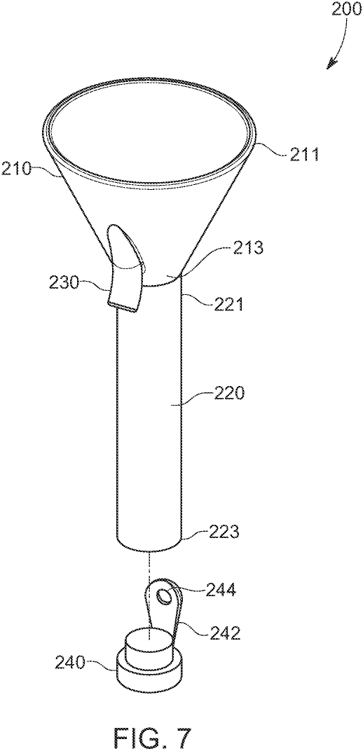

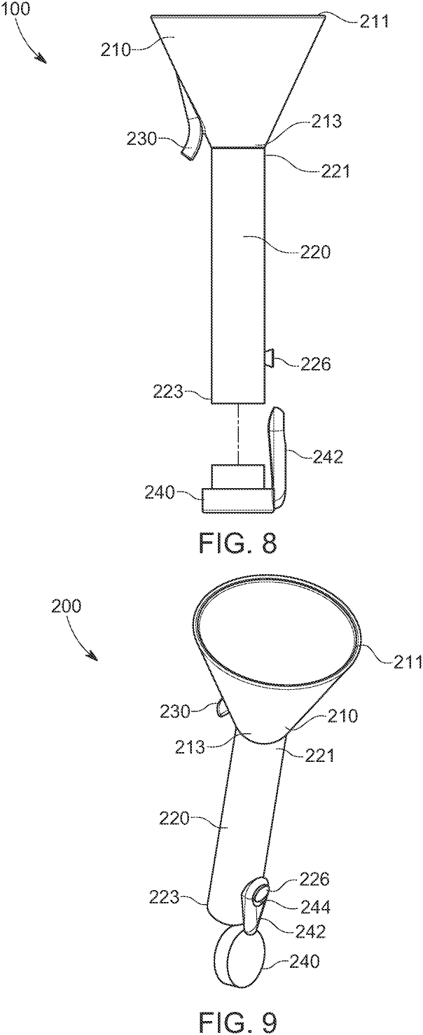

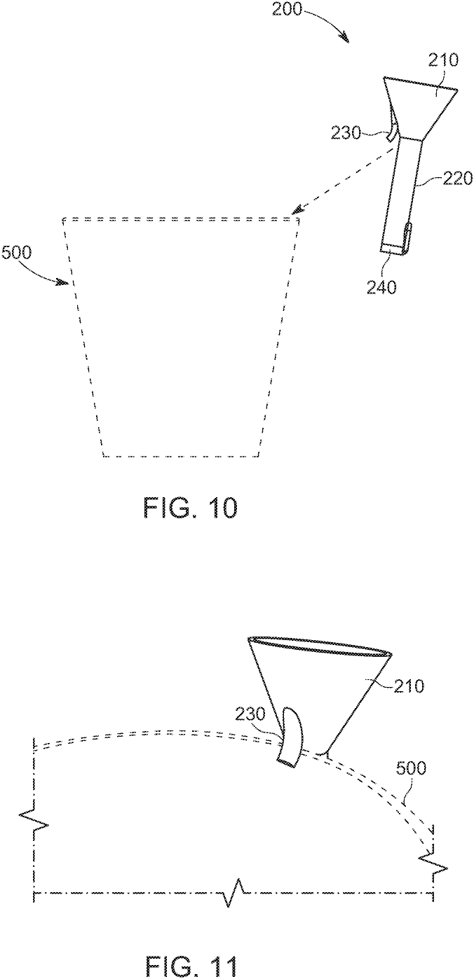

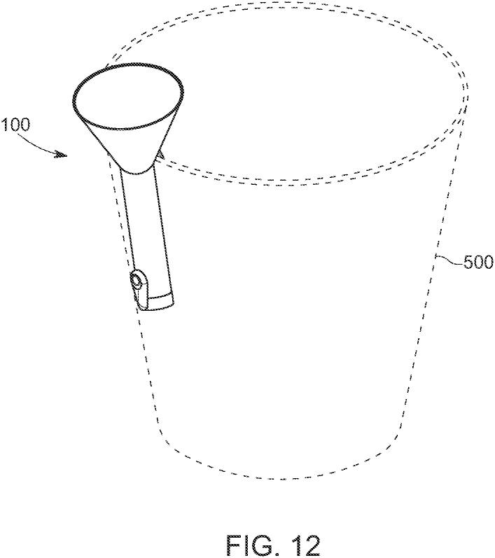

FIGS. 7 to 12 illustrate a non-limiting embodiment of a receptacle 200, which is an example of a reusable receptacle for receiving the inedible bits of popcorn and seeds in accordance with a non-limiting embodiment of the present invention. The receptacle 200 described in this embodiment may be useful in a domestic setting, such as at home where a consumer would prefer to have a reusable receptacle that can be cleaned after each use and reused. The receptacle 200 may generally be used with a bucket, a bowl, or any other receptacle that can be used by a consumer to carry an edible snack, such as popcorn or sunflower seeds. The receptacle type that can be used with the receptacle 200 will collectively be referred to as a bucket 500 (see FIG. 10). FIGS. 7, 8, and 9 illustrates a perspective view, a side view, and a top side perspective view of the receptacle 200, respectively. The receptacle is shown to comprise of a receiving unit 210 and a collection unit 220. The receiving unit 210 and the collection unit 220 are connected to each other such that the discarded bits from a consumer’s mouth move into the collection unit 220 from the receiving unit 210. FIGS. 7 and 8 illustrate that the receptacle 200 is configured with a flange 230 to attach onto a lip of a bucket 500. Further, the receptacle 200 of the present disclosure may also include a cap 240 at a bottom of the receptacle 200. The receptacle 200 is designed to be reusable and thus may be preferably fashioned from a sturdier material such as, and not limited to, plastic or silicone. It is to be understood that the receptacle 100 may also be fashioned from material that is recyclable.

The receiving unit 210 is connected to the collection unit 220. In the one or more non-limiting embodiments shown, the receiving unit 210 and the collection unit 220 may be integrated together such that the receiving unit 210 and the collection unit 220 are one piece or in other words are configured as a single piece. In alternate embodiments, the receiving unit 210 and the collection unit 220 may be two separate pieces that are removably adjoined together and can be separable after use to clean and store, if desired.

Like the above embodiment of receptacle 100, the receiving unit 210 of receptacle 200 is open and permits an easy access to spit out any inedible bits which are directed toward the collection unit 220. To permit an easy and hygienic means of spitting into the receptacle 200, the receiving unit 210 of the receptacle 200 may also have a funnel shape defined by a wider upper lip 211 at the opening for a mouth which depends downward toward a narrower bottom end 213 that connects to the collection unit 220. The advantage of the funnel shaped receiving unit 210 is the same as described above in the embodiment for the disposable receptacle 100, which is that the wider upper lip 211 with the narrower bottom end 213 helps contain any spray that exits an individual’s mouth when spitting into the receiving unit 210 and directs the bits toward the collection unit 220. Another advantage discussed above, is that the funnel shaped receiving unit 210 also that allows for discreetly spitting out any inedible bits by placing the mouth close to or within the receiving unit 210. It is to be understood that any other shape that directs the bits into the collection unit 220, offers discreetness, and maintains a hygienic environment by containing the spray exiting an individual’s mouth when spitting out the inedible bits is within the description of the present invention.

The collection unit 220 is connected to the narrower bottom end 213 of the receiving unit 210. In one or more embodiments, the collection unit 220 is tubular shaped and provides an interior space for collecting the inedible bits that are spat out by an individual. The collection unit 220 has a first end 221 and an opposing second end 223. The first end 221 is connected to the narrower bottom end 213 of the receiving unit 210. As shown in the figures, the collection unit 220 appears to have a circular cross section. It is to be understood that the collection unit 220 may have any cross-sectional shape including and not limited to an oval, a rectangle, a triangle, a trapezoid, and a polygon.

The second end 223 of the collection unit 220 is closed by the cap 240. The cap 240 fits within an opening at the second end 223 to seal the collection unit 220. As mentioned above, the cap 240 is configured to fit within the opening at the second end 223 and seal the opening. The shape of the cap 240 is dependent on the cross-sectional shape of the collection unit 220. The cap 240 is removable from the second end 223 for disposal of the collected refuse and cleaning. The cap 240 includes a flexible clip 242 with an opening 244. The opening in the flexible clip 242 is configured to clip onto a protrusion 226 on an outside surface of the collection unit 220. The protrusion 226 is proximal to the second end 223 of the collection unit 220 such that the cap 240 can stretch into the opening in the second end 223 when the flexible clip 242 is connected to the protrusion 226. Additionally, as shown in FIG. 9, when the flexible clip 242 of the cap 240 is connected to the protrusion 226, the cap 240 can be removed from the opening in the second end 223 while the retaining the cap 240 alongside for easy cleanup of the receptacle 200.

The collection unit 220 may be configured to come in varying lengths to fit onto an appropriately sized bowl or bucket. In an embodiment where the collection unit 220 and the receiving unit 210 are two separate pieces that can be attached and disconnected, a consumer may be able to collect collection units 220 with varying length, such that the consumer may connect a collection unit 220 having the appropriate length commensurate to a length of a bowl or bucket being used.

In an alternate non-limiting embodiment, the collection unit 220 may also have a flexible structure which can be extendable and bendable. In this embodiment, the flexible structure facilitates the positioning of the receiving unit 210 to an individual’s preference by moving the collection unit 220 by bending, extending, or retracting. This is advantageous because the flexibility of the collection unit 220 may make it easier for an individual to position the receptacle 200 which does not require the individual to move their heads or necks too much to access the receiving unit for spitting out the inedible bits. Additionally, such an embodiment may also add the flexibility of extending the collection unit 220 to suit a length of the bowl or bucket the receptacle 200 may be connected to.

FIGS. 7-12 also illustrate the receptacle 200 comprising of the attachment piece 230 which may be provided for attaching the receptacle 200 to a bucket or bowl that an individual is using to consume a snack from. As shown in FIGS. 10-12, the receptacle 200 is attached to the popcorn bag 500. In the one or more embodiments shown, the attachment piece 230 may be a projection extending outward from an outside surface of the receiving unit 210, like a flange, serving to hook onto a lip of the bucket 500. As shown, the attachment piece 230 is configured on an outside surface of the receiving unit 210. However, it is to be understood that the attachment piece 230 may also be configured on an outside surface of the collection unit 220. It is also to be understood that the attachment piece 230 can also take on other forms or shapes, such as and not limited to a clip or a hook.

In other non-limiting embodiments, the receptacle described in the present invention may be constructed in a variety of shapes, colors, sizes, materials, and may incorporate embellishments such as logos, designs, engravings, glowing or lighting elements, and key chain loops or straps.

Accordingly, the present description provides one or more embodiments for a useful receptacle with many benefits. It may be an advantage of the receptacle, as described herein in one or more embodiment, that an individual is able to enjoy a snack such as popcorn or sunflower seeds which requires the individual to spit out the inedible bits. The receptacle provides a useful and easily accessible device which can attach to the snack bag. The receptacle also prevents the spread of germs by containing the spray of spit within the receptacle. Additionally, the receptacle provides a discrete way of spitting out the inedible bits and further prevents an individual from spitting out the inedible pieces onto the floor. Thus, the receptacle, as described in one or more non-limiting embodiments throughout this document, offers an improved method and device for discarding the inedible bits that tend to accompany certain food items requiring the need to be discarded by spitting out.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A receptacle for collecting inedible food items discarded by spitting, the receptacle comprising:
a receiving unit having an upper end and a lower end, wherein the receiving unit is configured to contain an act of spitting;
a collection unit having an open end and closed end, wherein the open end is connected to the lower end of the receiving unit;
wherein the receptacle is contained within a bag having a seal at a top end, wherein the top end of the bag can be opened to remove the receptacle, wherein the bag creates a pocket when unsealed to hold the collection unit of the receptacle inside the bag with the receiving unit positioned outside the bag.

2. The receptacle of claim 1, wherein the bag has an adhesive backing, wherein the bag can be adhered to an outside surface of a container.

3. The receptacle of claim 1, wherein the upper end is wider than the lower end, wherein the upper end is at an opening of the receiving unit, and wherein the upper end depends downward toward the narrower lower end which is integrated to the collection unit.

4. The receptacle of claim 3, wherein the upper end is connected to a sleeve, wherein the sleeve closes the opening, and where the sleeve is removable.

5. The receptacle of claim 4, wherein the connection of the sleeve and the upper end is perforated.

6. The receptable of claim 4, wherein the sleeve includes a toothpick.

7. The receptacle of claim 6, wherein the toothpick is disposed within a tubular section of the sleeve dimensioned to fit the toothpick.

8. The receptacle of claim 1, wherein the collection unit has a length that is folded to store the receptacle within the bag, wherein the collection unit is unfolded to use, and wherein at least a partial length of the collection unit can fit within the pocket created by the unsealed bag.

9. The receptacle of claim 1, wherein the bag containing the receptacle is resealable.

10. The receptacle of claim 1, wherein the receptacle is fashioned from a fibrous material used to make paper, wherein the fibrous material is selected from the group comprising of fiber from wood, bamboo, cork, cotton, hemp, mulberry, and combinations thereof.

11. A receptacle for collecting inedible food items discarded by spitting, the receptacle comprising:
a receiving unit having an upper end and a lower end, wherein the receiving unit is configured to contain an act of spitting;
a collection unit having a first end and a second end, wherein the first end is connected to the lower end of the receiving unit, wherein the first end and the second end are open; and
a cap connectable to an opening at the second end to close the open second end.

12. The receptacle of claim 11, wherein the upper end is wider than the lower end, wherein the upper end is at an opening of the receiving unit, and wherein the upper end depends downward toward the narrower lower end which is integrated to the collection unit.

13. The receptacle of claim 11, wherein the receiving unit and the collection unit are configured as a single piece.

14. The receptacle of claim 11, wherein the receiving unit and the collection unit are removably adjoined and are separable.

15. The receptacle of claim 11, wherein the collection unit has a cross section selected from the group consisting essentially of a rectangular cross section, a circular cross section, a triangular cross section, a trapezoidal cross section, a polygonal cross section, and an oval cross section.

16. The receptacle of claim 11, wherein the cap is attachable to an outside surface of the second end.

17. The receptacle of claim 16, wherein the cap has a flexible clip with an opening, wherein the opening fits over a protrusion included on the outside surface of the second end proximal to the opening on the second end, and
wherein the cap connected to the protrusion can stretch to cover the opening in second end.

18. The receptacle of claim 11, wherein the cap is removable from the opening in the second end.

19. The receptacle of claim 11, further comprising an attachment piece configured on an outside surface of the receptacle, wherein the attachment piece is configured to connect onto a lip of a container.

20. The receptacle of claim 19, wherein the attachment piece projects outward from the receptacle and hooks onto the lip of the container.
